(19) United States
(12) Patent Application Publication
(10) Pub. No.: US 2011/0083121 A1
(43) Pub. Date: Apr. 7, 2011

(54) Method and System for Automatic Test-Case Generation for Distributed Embedded Systems

(75) Inventors: Manoj G. Dixit, Bangalore (IN); Ambar A. Gadkari, Bangalore (IN); Rajeev A C, Bangalore (IN); Ramesh Sethu, Bangalore (IN); Sathyaraja H. Nandugudi, Bangalore (IN)

(73) Assignee: GM GLOBAL TECHNOLOGY OPERATIONS, INC., Detriot, MI (US)

(21) Appl. No.: 12/572,291

(22) Filed: Oct. 2, 2009

(51) Int. Cl. G06F 9/44

(52) U.S. Cl. 717/124

(57) ABSTRACT

An automatic test-case generation system generates test-cases for validating a test specification for timing constraints, fault tolerances, distributed deadlocks, and synchronization at a system integration level of a distributed system. The automatic test-case generation system includes a model transformer for integrating functional model and platform specification. The functional model relates to an abstract model of at least one controller and the platform specification relates to details of platform components. A test specification transformer integrates platform specification, real-time requirements, and structural coverage criteria for generating an enhanced test specification for testing the distributed system. A requirements transformer integrates real-time requirements and functional requirements for the distributed system. An automatic test-case generator generates a set of test-cases that validate the test specifications of the distributed system as a function of the outputs of the model transformer, test specification transformer, and requirements transformer.

### BACKGROUND OF INVENTION

An embodiment relates generally to testing in-vehicle distributed embedded systems.

In automobiles, several vehicle feature functions are handled by electronics and control software applications. Such systems are distributed real-time embedded software systems that require high integrity development and verification processes. Ensuring consistency and correctness of models across the various design steps is critical in development methodologies. Automotive software is typically created as an initial abstract model of a controller which is then validated using physical testing or formal verification and is refined iteratively. Test sequences created to test the software are a series of commands or instructions that are applied to a device, subsystem or system under test. Physical testing typically requires the setup of a test bed or physical components in an actual vehicle using the actual architecture required for testing or validation. Moreover manual inspection, monitoring, and changes to the physical devices or software are labor intensive, time consuming, and costly.

### SUMMARY OF INVENTION

An advantage of an embodiment is the automated test-case generation for testing end-to-end implementation for a vehicle feature including one or more electronic control units utilizing embedded software under real-time requirements.

An embodiment contemplates an automatic test-case generation system for in-vehicle distributed embedded systems. The automatic test-case generation system generates test-cases for validating a test specification for timing constraints, fault tolerances, distributed deadlocks and synchronization at a system integration level of the distributed system. The automatic test-case generation system includes a model transformer for integrating a functional model and a platform specification. The functional model relates to an abstract model of at least one controller. The platform specification corresponds to a distributed architecture of the in-vehicle distributed embedded system and a mapping of software components to the distributed architecture. A test specification transformer integrates the platform specification, real-time requirements and structural coverage criteria for generating an enhanced test specification for testing the in-vehicle distributed embedded system. A requirements transformer integrates real-time requirements and functional requirements of the in-vehicle distributed embedded system. An automatic test-case generator generates a set of test-cases that validate the enhanced test specification of the in-vehicle distributed embedded system. The test-cases are generated as a function of the outputs of the model transformer, the test specification transformer, and the requirements transformer.

An embodiment contemplates a method for generating automatic test-cases for in-vehicle distributed embedded systems. The automatic test-cases being generated for validating a test specification for timing constraints, fault tolerances, distributed deadlocks, and synchronization at a system integration level of the distributed system. The method includes integrating a functional model relating to an abstract model of at least one controller with a platform specification. The platform specification corresponds to a distributed architecture of the in-vehicle distributed embedded system and a mapping of software components to the distributed architecture. The platform specification, real-time requirements, and structural coverage criteria are integrated for generating an enhanced test specification for testing the in-vehicle distributed embedded system. The real-time requirements and functional requirements are integrated for the in-vehicle distributed embedded system. A set of test-cases are automatically generated that validate the enhanced test specifications of the in-vehicle distributed embedded system. The test-cases are generated as a function of outputs of the model transformer, test specification transformer, and requirements transformer.

### BRIEF DESCRIPTION OF DRAWINGS

FIG. 1 is a block diagram of an automatic test generation system according to an embodiment of the invention.

FIG. 2 is an exemplary block diagram of a SL/SF model for an adaptive cruise control (ACC) system according to an embodiment of the invention.

FIG. 3 is a block diagram of an annotated SL/SF model for an adaptive cruise control (ACC) system according to an embodiment of the invention.

FIG. 4 is an exemplary table illustrating task parameters according to an embodiment of the invention.

FIG. 5 is an exemplary table illustrating message parameters according to an embodiment of the invention.

FIG. 6 illustrates a flowchart of a method for automatically generating test-cases according to an embodiment of the invention.

### DETAILED DESCRIPTION

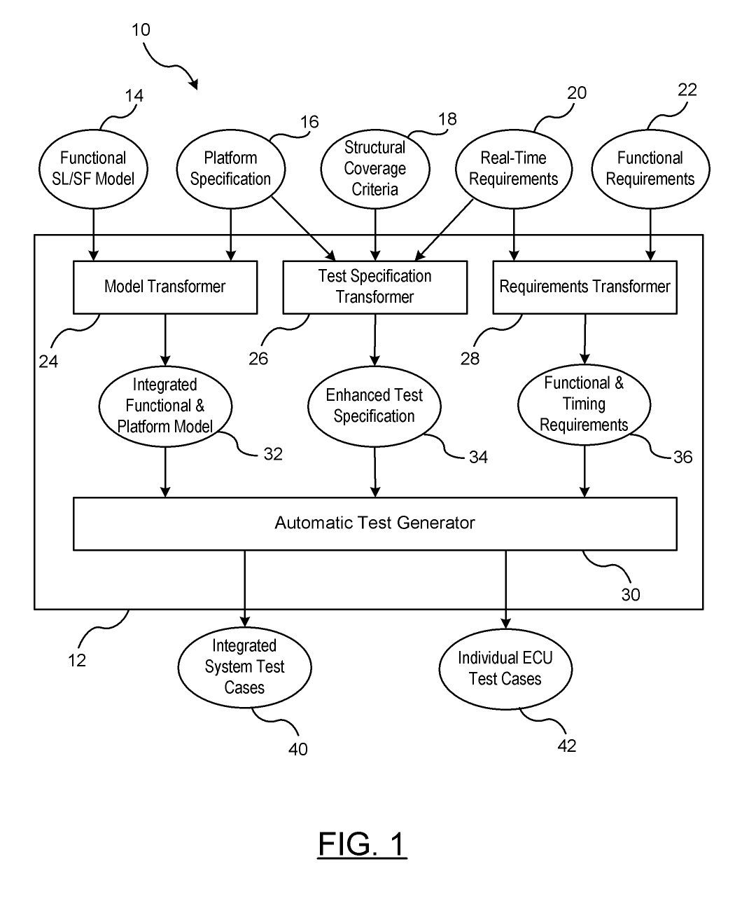

There is shown generally in FIG. 1 a block diagram of an automatic test generation system 10 for generating a set of test-cases that satisfies a validation of test specifications and requirements. A plurality of inputs is provided to an automated test generation module 12. The plurality of inputs includes, but is not limited to, a functional model 14 of a vehicle feature (e.g., system, subsystem, or device), platform specifications 16, structural coverage criteria 18, real-time requirements 20, and functional requirements 22.

The automated test generation module 12 includes a plurality of transformer modules for integrating two or more inputs. The plurality of transformer modules includes a model transformer 24, a test specification transformer 26, and a requirements transformer 28. Each of the respective transformers processes the inputs and produces outputs that are provided to an automatic test generator 30. The respective outputs from the transformers include an integrated functional and platform model 32, an enhanced test specification 34, and integrated functional and timing requirements 36. The automated test generator 30 outputs integrated-system test-cases 40 and individual controller test-cases 42. The test-cases may be executed using a harness that can trigger the inputs in any of the components of the systems for which the model is supplied.

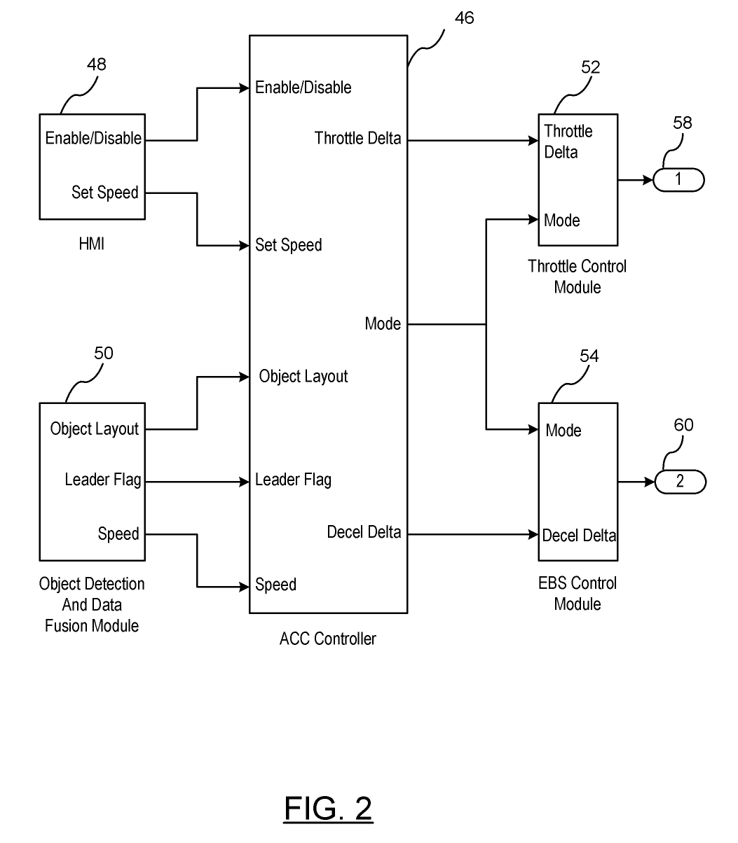

The functional model 14 is created as an initial abstraction using a modeling language, such as Simulink/Stateflow (SL/SF). FIG. 2 illustrates an exemplary SL/SF model of an adaptive cruise control (ACC) system. It should be understood that the example as described herein is for exemplary purposes only and any vehicle feature may be modeled and tested utilizing the techniques described herein.

The model as shown in FIG. 2 includes a controller 46 (e.g., ACC controller) having at least one input device. The input devices as shown in FIG. 2 include a human machine interface (HMI) 48 and an object detection & data fusion module 50. Inputs such as enable/disable ACC functionality, set speed, object layout, leader flag, and speed are provided to the controller 46. At least one output device is provided for receiving outputs from the controller 46. Output devices, as shown in FIG. 2, include control modules such as a throttle control module 52 and an electronic braking system module 54 that assist in automatically controlling the speed of the vehicle. Respective output control signals 58 and 60 are output from the throttle control module 52 and the electronic braking system module 54 for controlling the ACC feature.

The platform specification 16 refers to the distributed architecture in addition to the mapping of software components within the distributed architecture. The distributed architecture includes task scheduling policy of the controllers (e.g., preemptive, non-preemptive), network topology (e.g., interconnections among the controllers by communication buses), characteristics of the buses (e.g., baud rate, protocols such as CAN or FlexRay), data access, fault management, real-time data acquisition, and security.

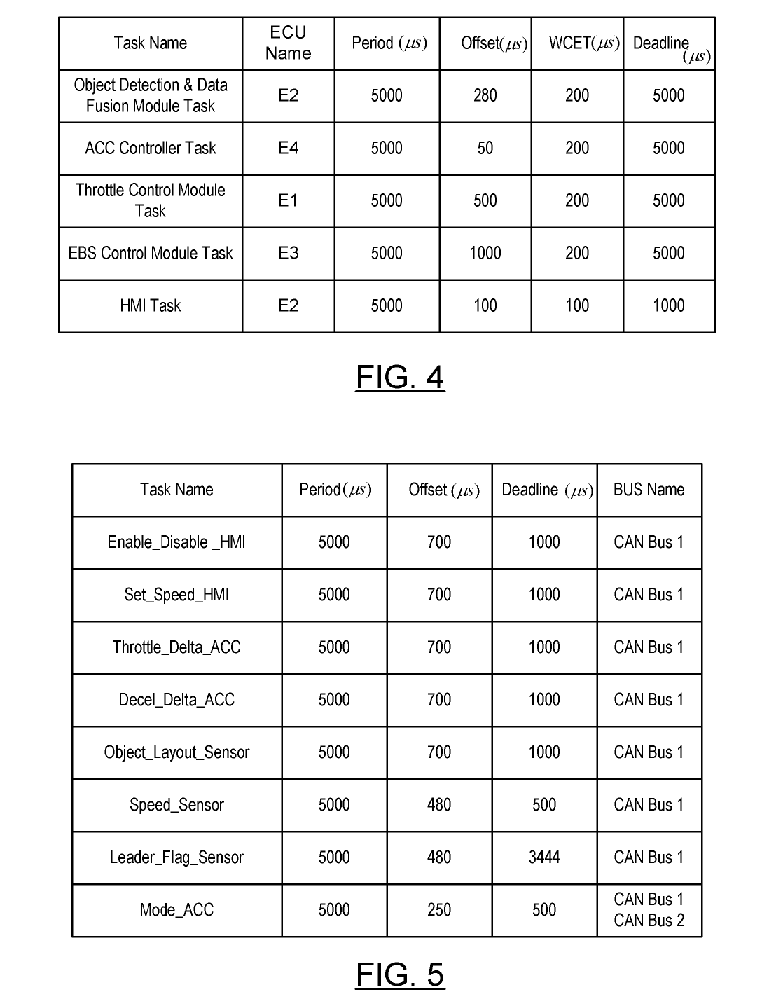

The task scheduling determines the execution order of the tasks. Each task is selected and executed in a respective order according to the scheduling policy. For example, in preemptive scheduling, a scheduler is allowed to stop an execution of a task before the task has completed its execution, in order to execute another task. The interrupting task may have a greater importance or priority in the task scheduling policy. When the interrupting task has completed its execution, the preempted task resumes its execution. In non-preemptive task scheduling, the task that is currently being executed is allowed to complete its execution regardless of the importance or priority of other tasks. FIG. 4 illustrates a table of task parameters and FIG. 5 illustrates a table of message parameters. Each of the respective tables illustrates the criteria (e.g., period, offset, worst case execution time, deadline, bus name, and ECU name) at which a respective task is executed or a message is communicated. The tasks implementing the functional blocks and the messages communicated between the functional blocks are repeated periodically, based on the periods set forth in the tables of FIGS. 4 and 5. Specific periods of time, referred to as offsets, give the initial times at which the tasks and messages are triggered. The next set of functional blocks compute their outputs after all inputs provided by the first set of functional blocks are received. Thereafter, output functional blocks are triggered for producing outputs from the system. End-to-end timing constraints are used to compute the response rates of the system.

Feature deployment includes the mapping of components/functions to tasks which implement the functionality; the mapping of tasks to controllers on which the tasks will be scheduled; the mapping of signals to messages (e.g., data transfer between components); and the mapping of messages to buses which carry the messages.

The structural coverage criteria 18 define a set of rules that guides test-case generation, based on coverage of model structure. Various structural coverage criteria defined over model elements include, but are not limited to, condition coverage, decision coverage, Modified Condition/Decision Coverage (MC/DC), state coverage, and transition coverage.

Real-time requirements 20 are the timing requirements for tasks, messages, and other aspects of the distributed system under test. Tasks and messages require verification to ensure that each task and message is meeting its respective deadline. The deadline indicates a time interval in which a respective task or message should be executed. For a task or message requirement, deadlines are verified using offsets, periods, and worst-case execution times (WCET) as illustrated in FIGS. 4 and 5. Real-time requirements for a vehicle feature can be some constraints based on the end-to-end response time of the feature. In the example of ACC, a real-time requirement may be “whenever a leading vehicle slows down, ACC shall apply the brake within 100 ms.”

Functional requirements 22 are conditions/criteria that determine the correct functioning of the controller software. An example of a functional requirement in the case of the ACC is as follows: “whenever a leading vehicle slows down, ACC shall apply the brake.”

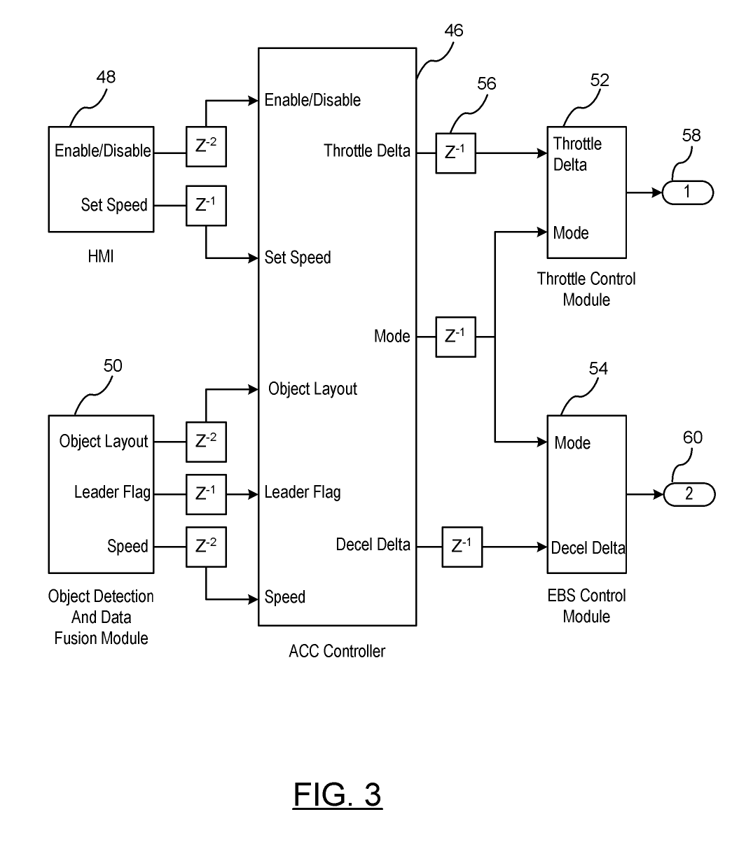

The model transformer 24 receives the functional model 14 and the platform specification 16, and outputs a modified model 32 that incorporates the platform specification. The platform specification 16 provides details of buses, task schedulers, and middleware components for integrating with the functional model 14. An objective of the model transformer 24 is to transform the functional SL/SF model so that timing effects due to the implementation of the controller on a distributed platform are incorporated. FIG. 3 illustrates an example of a modified SL/SF model for an adaptive cruise control (ACC) system. One or more delay devices 56 may be used for delaying the input signals to the controller 46 and/or for delaying output signals from the controller 46 to the output devices. Alternatively, the modified model 32 in FIG. 1 may be represented as a timed transition system.

The test specification transformer 26 receives the platform specification 16, the structural coverage criteria 18 and the real-time requirements 20, and integrates them accordingly. The real-time requirements 20 and the platform specification 16 provide coverage criteria for message activations, task activations, etc. The test specification transformer 26 produces an enhanced test specification for testing the distributed system. In addition to the model structural coverage criteria (e.g., state coverage, transition coverage, MC/DC), additional coverage criteria will include covering elements of the platform specification such as triggering of particular tasks and generation of particular messages by tasks.

The inputs to the requirements transformer 28 are the functional requirements 22 and the real-time requirements 20. The requirements transformer 28 integrates the real-time requirements and the functional requirements, and provides modified requirements containing both functional and timing constraints for the featured system, subsystem, or component.

The automatic test generator 30 receives the integrated functional and platform model 32, the enhanced test specification 34 and the functional and timing requirements 36, and generates test-cases that satisfy the test specification/requirements. The automatic test generator 30 is preferably based on a model checking method. Alternatively, other approaches for generating test-cases, such as test generators based on random/directed simulation or constraint solving, may be used. Test-cases are generated at the feature level (for testing the integrated system), and/or the subsystem level (for testing individual controllers).

It should be understood that a vehicle feature may include more than one processing unit (i.e., ECU), and each of the processing units, supporting modules, and devices are executed in parallel. Therefore, a test harness can be utilized to automatically trigger the inputs to any of the respective components for testing and validating the distributed system and the associated embedded software, using the generated test-cases. It should also be understood that the system and methods described herein can be applied to any device, subsystem or system that utilizes embedded software.

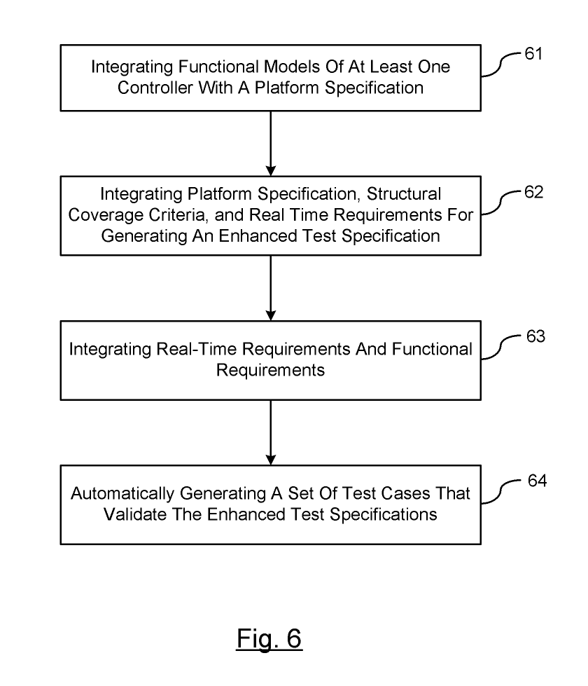

FIG. 6 illustrates a method for automated generation of test-cases for testing in-vehicle distributed embedded systems. In step 61, a functional model relating to an abstract model of at least one controller is integrated with the platform specification where the platform specification relates to platform components.

In step 62, platform specification, structural coverage criteria, and real-time requirements are integrated for generating an enhanced test specification for testing the distributed system.

In step 63, real-time requirements and functional requirements for the distributed system are integrated.

In step 64, a set of test-cases are automatically generated as a function of the outputs of the model transformer, the test specification transformer, and the requirements transformer.

While certain embodiments of the present invention have been described in detail, those familiar with the art to which this invention relates will recognize various alternative designs and embodiments for practicing the invention as defined by the following claims.

What is claimed is:

1. An automatic test-case generation system for in-vehicle distributed embedded systems, the automatic test-case generation system generating test-cases for validating a test specification for timing constraints, fault tolerances, distributed deadlocks and synchronization at a system integration level of the in-vehicle distributed embedded system, the automatic test-case generation system comprising:
a model transformer for integrating a functional model and a platform specification, the functional model relating to an abstract model of at least one controller, and the platform specification corresponding to a distributed architecture of the in-vehicle distributed embedded system and a mapping of software components to the distributed architecture;
a test specification transformer for integrating the platform specification, real-time requirements and structural coverage criteria for generating an enhanced test specification for testing the in-vehicle distributed embedded system;
a requirements transformer for integrating real-time requirements and functional requirements of the in-vehicle distributed embedded system; and
an automatic test-case generator for generating a set of test-cases that validate the enhanced test specification of the in-vehicle distributed embedded system, the test-cases being generated as a function of the outputs of the model transformer, the test specification transformer, and the requirements transformer.

2. The system of claim 1 wherein the set of test-cases output from the automatic test-case generator includes test-cases for testing communications between controllers within the in-vehicle distributed embedded system.

3. The system of claim 1 wherein the set of test-cases output from the automatic test-case generator includes test-cases for testing responses of controllers within the in-vehicle distributed embedded system.

4. The system of claim 1 wherein the platform specification corresponds to parameters of communication buses.

5. The system of claim 1 wherein the platform specification corresponds to parameters related to task scheduling on the controllers.

6. The system of claim 1 wherein the platform specification corresponds to parameters of middleware components.

7. The system of claim 1 wherein the functional model is a Simulink/Stateflow model.

8. The system of claim 1 wherein the model transformer utilizes timing effects that result from an implementation of the controller on a distributed platform.

9. The system of claim 1 wherein the integrated functional and platform model produced by the model transformer includes timing information of tasks and messages, wherein the integrated functional and platform model captures a duration of time for execution of tasks and transmission of messages between communication devices of the in-vehicle distributed embedded system.

10. The system of claim 1 wherein the integrated functional and platform model is an annotated Simulink/Stateflow model.

11. The system of claim 1 wherein the integrated functional and platform model is represented using a timed transition system.

12. A method for automatically generating test-cases for in-vehicle distributed embedded systems, the test-cases being generated for validating a test specification for timing constraints, fault tolerances, distributed deadlocks, and synchronization at a system integration level of the in-vehicle distributed embedded system, the method comprising the steps of:
integrating a functional model relating to an abstract model of at least one controller with a platform specification, the platform specification corresponding to a distributed architecture of the in-vehicle distributed embedded system and a mapping of software components to the distributed architecture;
integrating platform specification, real-time requirements, and structural coverage criteria for generating an enhanced test specification for testing the in-vehicle distributed embedded system;
integrating real-time requirements and functional requirements for the in-vehicle distributed embedded system; and
automatically generating a set of test-cases that validate the enhanced test specifications of the in-vehicle distributed embedded system, the test-cases being generated as a function of outputs of the model transformer, test specification transformer, and requirements transformer.

13. The method of claim 12 wherein test-cases are output from an automatic test-case generator for testing communications between controllers within the in-vehicle distributed embedded system.

14. The method of claim 12 wherein test-cases are output from an automatic test-case generator for testing responses of controllers within the in-vehicle distributed embedded system.

15. The method of claim 12 wherein timing delays are used to capture a duration of time for execution of tasks and transmission of messages between the communication devices within the in-vehicle distributed embedded system.

16. The method of claim 15 wherein the timing delays due to tasks and messages are included in the integrated functional and platform model.

17. The method of claim 12 wherein the integrated functional and real-time requirements are modeled using a timed transition system.

18. The method of claim 12 wherein test-cases are generated for providing a sequence of input signals and output signals at a subsystem level for testing individual controllers.

19. The method of claim 12 wherein test-cases are generated for providing a sequence of input signals and output signals at a system integration level for the in-vehicle distributed embedded system.

20. The method of claim 12 wherein a sequence of input signals and output signals are tested at fixed timing steps.

21. The method of claim 12 wherein a sequence of input signals and output signals are tested at variable timing steps.

22. The method of claim 12 wherein the test-cases are executed on a test harness.
